(19) United States
(12) Patent Application Publication
(10) Pub. No.: US 2015/0138013 A1
(43) Pub. Date: May 21, 2015

(54) APPARATUS AND METHOD FOR POSITIONING WLAN TERMINAL

(71) Applicant: ELECTRONICS AND TELECOMMUNICATIONS RESEARCH INSTITUTE, Daejeon (KR)

(72) Inventors: Sok-Joon LEE, Daejeon (KR); Hyeok-Chan KWON, Daejeon (KR); Jong-Sik MOON, Daejeon (KR); Gae-Il AN, Daejeon (KR); Do-Young CHUNG, Daejeon (KR); Sin-Hyo KIM, Daejeon (KR)

(73) Assignee: ELECTRONICS AND TELECOMMUNICATIONS RESEARCH INSTITUTE, Daejeon (KR)

(21) Appl. No.: 14/314,208

(22) Filed: Jun. 25, 2014

(30) Foreign Application Priority Data
Nov. 21, 2013 (KR) 10-2013-0142359

(51) Int. Cl. G01S 3/58

(52) U.S. Cl. CPC G01S 3/58
USPC 342/351

(57) ABSTRACT

A WLAN terminal positioning apparatus includes a directional antenna module including a directional antenna, a first motor, and a second motor wherein the second motor is combined with a shaft of the first motor and the directional antenna is combined with a shaft of the second motor such that the directional antenna has a hemispherical search range, where an angle of the maximum signal strength of the signal received by the directional antenna from the WLAN terminal is measured while the first motor or the second motor is rotated, and an estimated physical position of the WLAN terminal is calculated using a directional direction of the directional antenna.

### CROSS-REFERENCE TO RELATED APPLICATION

This application claims priority to and the benefit of Korean Patent Application No. 10-2013-0142359, filed on Nov. 21, 2013, the disclosure of which is incorporated herein by reference in its entirety.

### BACKGROUND

1. Field of the Invention

The present invention relates to a wireless local area network (WLAN) terminal positioning apparatus and method.

2. Discussion of Related Art

IEEE 802.11-based wireless local area network (WLAN) technology allows terminals to quickly and inexpensively use a network without a wired connection and thus is widely used in homes, businesses, and public networks. In particular, as notebooks, smartphones, and tablets having WLAN cards installed therein are widely used, users can use games, web surfing, news, social services, etc. through the Internet during daily activities at any time and any place and easily utilize a variety of Internet-based application services such as mail transmission and reception. In particular, introduction of high speed technology such as 802.11n, 802.11ac, etc. and security enhanced technology such as 802.11i, 802.11w, etc. allows users to use safer and more convenient WLAN technology.

However, even when the security enhanced technology is applied, there is vulnerability due to wireless characteristics. Unlike wired technology, wireless technology is vulnerable to various attacks such as address spoofing, eavesdropping, packet forgery, etc. because anyone can access the network and it is difficult to find an actual physical position of a network access point.

Attacks on WLANs provided in homes, businesses, and public networks are as follows.

1) Rogue Access Point (AP)

The term “rogue AP” collectively refers to APs that are illegally installed and used with no permission, which are largely classified into two types.

The first type of rogue AP is a rogue AP that is connected to an intranet of a business by cable to provide WLAN services. This AP is used as a means for attackers to bypass a firewall, a wired IDS/IPS, etc. to easily access the intranet using the rogue AP. That is, the rogue AP is connected to the intranet by cable to serve as an illegal path for attackers to easily and wirelessly access the intranet. In this case, the attackers can easily access a server or PC that stores important information about a business without authority to access the intranet.

The second type of rogue AP is a rogue AP that is connected to the Internet in a variety of manners (tethering, Soft AP, etc.). This AP provides WLAN services as if it was a normal AP, and is used as a means to attempt attacks such as information leakage by eavesdropping or forging data communicated between connected terminals. A normal terminal accesses a smartphone that provides a tethering service, not via a normal AP, to receive Internet service through a mobile communication base station. Generally, terminals in a business should access an extranet via an internal gateway, and thus a manager can establish a system that can prevent illegal leakage of data. However, if the terminals perform access via the rogue AP using the tethering smartphone, the manager loses a means to prevent the internal terminal from leaking data.

2) Denial-of-Service Attack

A WLAN defines and uses various kinds of wireless packets in order to avoid data collision and maintain a virtual connection between a terminal and an AP when both the terminal and the AP try to send data. However, when these packets are legally generated and used, it may be very effective in accomplishing the above objectives. When these packets are illegally forged and used, it may be difficult to maintain access between the normal terminal and the AP. This attack is referred to as a denial-of-service attack.

In the WLAN, a denial-of-service attack is performed in a variety of methods. For example, attackers may forge transmission and reception addresses of a deauthentication message for disconnection and send the forged transmission and reception addresses to a terminal and an AP that are connected, thereby allowing the connection to be disconnected. In addition, attackers generate a number of association messages each having differently forged transmission addresses and paralyze an access information management function of an AP, preventing the AP from providing WLAN services normally.

Also, attackers may attempt a denial-of-service attack by forging management frames in another manner or forging an EAPOL message essential for WLAN services with 802.1x-based user authentication (EAPOL-Start, EAPOL-Logoff, EAPOL/EAP-Failure, EAPOL/EAP-Success, etc.) or a control packet that is generated to avoid data collision of the WLAN (RTS/CTS, NAV, etc.).

3) WEP/WPA Key Cracking Attack

A WLAN includes technology for encrypting data packets using a shared key, or a key dynamically concurrent with the AP via 802.1x, such as WEP, WPA, and WPA2 technologies. WEP is very vulnerable to a key cracking attack, and WPA and WPA2 may also be vulnerable to key cracking attacks based on dictionary.

4) Insider Attack by Legally Accessed Terminal

A legal terminal that is normally authenticated and safely connected to the WLAN may attempt an insider attack. Such attacks may be classified into attacks using vulnerability of a WLAN specification and attacks performed in a layer higher than a WLAN layer. As an example of an attack using vulnerability of a WLAN specification, all terminals safely connected to the same AP through WPA/WPA2 share the same broadcast key. This key is used to encrypt a broadcast message of an AP. When there is an error in an MIC (integrity verification code) value of the encrypted message, the AP attempts new key sharing or ends the connection. Accordingly, the normal terminal may intentionally fabricate and send a frame inducing MIC failure, which has the same effect as a denial-of-service attack. This attack is possible similarly even in 802.11w, which is a standard for management frame protection.

As an example of an attack performed in a layer higher than a WLAN layer, a terminal connected to an AP may forge and send an ARP message to another terminal connected to the AP, and thus the ARP poisoning attack is possible. For example, when an attacker accesses the AP normally and sends the forged ARP message indicating that the attacker is a gateway to another terminal, the terminal will send the attacker all Internet packets to be transmitted to the outside. It is very difficult to effectively respond to this attack because the forged packet does not arrive at a wired IDS/IPS even when this attack is implemented in a layer higher than the Internet.

As such, there are a number of conventional technologies that can be used to safely manage a WLAN network that can receive various attacks.

First, there is a method using a WIDS/WIPS sensor to detect and respond to an invasion. The WIDS/WIPS sensor serves to continuously collect WLAN packets in a fixed position to detect and respond to the above attacks.

Second, there is a method using a mobile terminal to analyze and manage a network. The terminal may be easily carried by a manager and may serve to collect WLAN packets in a position desired by the manager to check a state of the network, that is, to check whether the quality of the network is normal or abnormal. Some terminals partially include the above-described function of the sensor.

Third, there is a method of testing vulnerability by adding an attack function to the second method. For example, the method may include a vulnerability analysis system including SSID variation attack and 802.1x-based denial-of-service attack functions.

These methods constantly or aperiodically monitor a WLAN and analyze packets collected as a result of the monitoring. In particular, the WIDS/WIPS system in the first method determines whether to receive an attack on the basis of the analyzed result. For prevention technologies, the sensor generates a wireless packet such as a deauthentication frame or a wired packet such as an ARP frame such that an attack terminal cannot communicate with other devices.

However, of course, this method cannot block the attack terminal directly. A defense technology for the attack terminal includes using a MAC address of the terminal to transmit data. But, the attack terminal generally forges its MAC address to continuously change its identification information when attempting an attack. And in that case, the wired/wireless packets for prevention may not be received by the attack terminal and thus blocking the attack terminal is limited. In addition, even when the specific packets are actually received by the attack terminal, the attack terminal may ignore the packets and continuously generate attack packets, which cannot be blocked.

Accordingly, it would be most desirable to find a physical position of the attack terminal as quickly as possible and then remove the attack terminal. There have been previous attempts to find an actual physical position of the attack terminal, in particular, a rogue AP. A widely used method is using signal strengths by the WIDS/WIPS sensors. The position is calculated using triangulation when three sensors are used and is calculated using a probability when two sensors are used. Using triangulation increases accuracy significantly. Otherwise, the position is difficult to calculate.

In addition, the WIDS/WIPS sensors may often be intentionally disposed not to overlay their monitoring areas in consideration of prices and installation costs of the WIDS/WIPS sensors. Alternatively, one or more sensors may be disposed on every floor in a small building. In this case, there is a low possibility that three or more sensors will receive a signal of a specific attack terminal. Accordingly, triangulation cannot be used, and thus it is difficult to accurately specify the position.

### SUMMARY OF THE INVENTION

The present invention is directed to an apparatus and method for positioning a wireless local area network (WLAN) terminal, which can accurately calculate a physical position of an attack terminal in a WLAN using an angle adjustable directional antenna module.

According to an aspect of the present invention, there is provided a WLAN terminal positioning apparatus that performs search of a WLAN terminal. The WLAN terminal positioning apparatus includes: a directional antenna module including a directional antenna, a first motor, and a second motor in which the second motor is combined with a shaft of the first motor and the directional antenna is combined with a shaft of the second motor such that the directional antenna has a hemispherical search range; a motor control module configured to control driving of the first motor and the second motor; a WLAN communication module configured to receive a signal from the directional antenna to measure signal strength of the signal, the signal being received by the directional antenna from the WLAN terminal to be positioned; and a positioning control module configured to receive a request to position the WLAN terminal, perform control such that the directional antenna measures signal strength of the signal received by the directional antenna from the WLAN terminal while the first motor or the second motor is rotated, detect angle information corresponding to a maximum signal strength for each of the first motor and the second motor, fix the first motor and the second motor using the detected angle information, and calculate an estimated physical position of the WLAN terminal using a directional direction of the directional antenna.

The first motor may have a shaft rotated in a horizontal direction with respect to a surface where the WLAN terminal positioning apparatus is disposed, the second motor may have a shaft combined with one end of the shaft of the first motor such that the shaft of the second motor is perpendicular to the shaft of the first motor and rotated in a vertical direction with respect to the rotation direction of the shaft of the first motor, and the directional antenna is combined with the shaft of the second motor such that a directional direction is rotated together with the shaft of the second motor.

The positioning control module may set the second motor such that the directional antenna is horizontal with respect to the surface at a search start timing, detect a first maximum signal strength among signal strengths of the WLAN terminal and horizontal angle information corresponding to the detected first maximum signal strength, the signal strengths being measured while the first motor is rotated 360 degrees, and perform control such that the first motor is fixed using the horizontal angle information.

The positioning control module may detect a second maximum signal strength among signal strengths of the WLAN terminal and vertical angle information corresponding to the detected second maximum signal strength, the signal strengths being measured while the second motor is rotated 90 degrees in an opposite direction with respect to the surface, and perform control such that the second motor is fixed using the vertical angle information.

The positioning control module may calculate a position indicated by the directional antenna fixed according to the horizontal angle information and the vertical angle information as an estimated physical position of the WLAN terminal.

According to another aspect of the present invention, there is provided a local area network (WLAN) terminal positioning method performed by a WLAN terminal positioning apparatus including a directional antenna module including a first motor, a second motor, and a directional antenna, in which the second motor is combined with a shaft of the first motor and the directional antenna is combined with a shaft of the second motor such that the directional antenna has a hemispherical search range.

The WLAN terminal positioning method includes: receiving a request to position a WLAN terminal; measuring signal strengths of a signal received by the directional antenna from the WLAN terminal while the first motor is rotated; detecting horizontal angle information corresponding to a maximum signal strength among the signal strengths measured according to rotation of the first motor; fixing the first motor using the horizontal angle information; measuring signal strengths of a signal received by the directional antenna from the WLAN terminal while the second motor is rotated; detecting vertical angle information corresponding to a maximum signal strength among the signal strengths measured according to rotation of the second motor; fixing the second motor using the vertical angle information; and calculating an estimated physical position of the WLAN terminal using the directional direction of the directional antenna.

The first motor may have a shaft rotated in a horizontal direction with respect to a surface where the WLAN terminal positioning apparatus is disposed, the second motor may have a shaft combined with one end of the shaft of the first motor such that the shaft of the second motor is perpendicular to the shaft of the first motor and rotated in a vertical direction with respect to the rotation direction of the shaft of the first motor, and the directional antenna may be combined with the shaft of the second motor such that a directional direction is rotated together with the shaft of the second motor.

The WLAN terminal positioning method may further include setting the second motor such that the directional antenna is horizontal with respect to the surface before the measuring of signal strengths of a signal received by the directional antenna from the WLAN terminal while the first motor is rotated, in which the measuring of signal strengths of a signal received by the directional antenna from the WLAN terminal while the first motor is rotated includes measuring the signal strengths while the first motor is rotated 360 degrees.

The measuring of signal strengths of a signal received by the directional antenna from the WLAN terminal while the second motor is rotated may include measuring the signal strengths while the second motor is rotated 90 degrees in an opposite direction with respect to the surface.

The calculating of the estimated physical position of the WLAN terminal may include calculating a position indicated by the directional antenna fixed according to the horizontal angle information and the vertical angle information as an estimated physical position of the WLAN terminal.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic block diagram of a WLAN terminal positioning apparatus; and

FIG. 2 is a flowchart illustrating a WLAN terminal positioning method.

### DETAILED DESCRIPTION OF EXEMPLARY EMBODIMENTS

While example embodiments of the invention are susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Moreover, detailed descriptions related to well-known functions or configurations will be ruled out in order not to unnecessarily obscure subject matters of the present invention. It is also be noted that, although ordinal numbers (such as first and second) are used in the following description, they are used only to distinguish similar components.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Preferred embodiments of the present invention will be described below in more detail with reference to the accompanying drawings. In describing the invention, to facilitate the entire understanding of the invention, like numbers refer to like elements throughout the description of the figures.

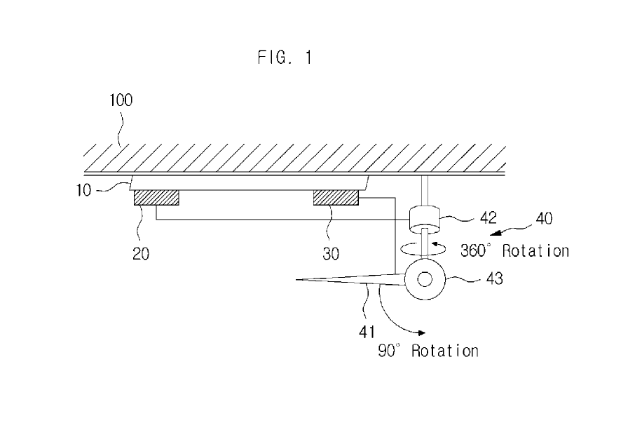

FIG. 1 is a schematic block diagram of a WLAN terminal positioning apparatus.

Referring to FIG. 1, the WLAN terminal positioning apparatus includes a positioning control module 10, a motor control module 20, a WLAN communication module 30, and a directional antenna module 40. As shown in FIG. 1, each module of the WLAN terminal positioning apparatus may be attached to a ceiling 100. Generally, a wireless intrusion detection/prevention system (WIDS/WIPS) sensor for continuously collecting WLAN packets in a fixed position to detect and respond to an attack of an attack terminal is disposed on the ceiling at a center of a specific region to monitor a wide range. Thus, in this specification, the WLAN terminal positioning apparatus may be disposed on the ceiling 100.

The directional antenna module 40 includes a directional antenna 41, a first motor 42, and a second motor 43.

The first motor 42 has a shaft that may be rotated 360 degrees horizontally with respect to the surface where the first motor 42 is disposed.

The second motor 43 has a shaft that is vertically combined with an end of the shaft of the first motor 42 and rotated 90 degrees vertically with respect to the rotational direction of the first motor 42.

The directional antenna 41 is combined with the shaft of the second motor 43 such that a directional direction is rotated together with the shaft of the second motor 43.

Accordingly, the directional antenna module 40 may be configured by combining the second motor 43 to the shaft and combining the shaft of the second motor 43 with the directional antenna 41 such that the directional antenna 41 has a hemispherical search range. That is, the directional antenna 41 may receive signals from the WLAN terminal while the shaft of the first motor 42 is rotated 360 degrees horizontally, and the shaft of the second motor 43 is rotated 90 degrees vertically with respect to the rotational direction of the first motor 42. In this case, when the directional antenna 41 directs the WLAN terminal accurately, the strength of the received signal may increase.

The motor control module 20 generates driving control signals for the first motor 42 and the second motor 43 according to a control instruction of the positioning control module 10 to deliver the driving control signals to the first motor 42 and the second motor 43. For example, the motor control module 20 may generate a driving control signal for rotating the first motor 42 360 degrees and when the rotation of the first motor 42 is completed, generate a driving control signal for rotating the second motor 43 90 degrees. In this case, the motor control module 20 may continuously deliver rotation angle information of each motor to the positioning control module 10 while the first motor 42 or the second motor 43 is rotated.

The WLAN communication module 30 receives a signal from the directional antenna 41, which receives a signal from a WLAN terminal to be positioned, to measure signal strengths of the signal and deliver the measured signal strengths to the positioning control module 10. For example, the WLAN communication module 30 may measure signal strengths of the signals continuously delivered for each directional direction of the directional antenna 41 according to the rotation of the first motor 42 or the second motor 43.

The positioning control module 10 controls the directional antenna module 40 through the motor control module 20 and the WLAN communication module 30 to detect a physical position of the WLAN terminal to be positioned.

For example, the positioning control module 10 may receive a positioning request from a user, generate an instruction to be delivered to the motor control module 20 for controlling an operation of the directional antenna module 40 and an instruction to be delivered to the WLAN communication module 30 such that the WLAN communication module 30 receiving the signal received by the directional antenna module 40 may measure signal strengths, and deliver the instructions to the motor control module 20 and the WLAN communication module 30.

For example, the directional antenna 41, as shown in FIG. 1, may be disposed horizontally with respect to the ceiling 100, that is, vertically with respect to the shaft of the first motor 42, at a search start timing. Thus, the positioning control module 10 may detect a maximum signal strength among signal strengths of the WLAN terminal measured while the first motor 42 is rotated 360 degrees, and detect horizontal angle information corresponding to the detected maximum signal strength. Next, the positioning control module 10 may perform control such that the first motor 42 is fixed at a horizontal angle corresponding to the maximum signal strength, detect a maximum signal strength among signal strengths of the WLAN terminal measured while the second motor 43 is rotated 90 degrees in the opposite direction with respect to the ceiling 100, and detect vertical angle information corresponding to the detected maximum signal strength. Next, the positioning control module 10 may perform control such that the second motor 43 is fixed at a vertical angle corresponding to the maximum signal strength.

Thus, the positioning control module 10 may use the horizontal angle information and vertical angle information corresponding to the maximum signal strength to calculate an estimated physical position of the WLAN terminal to be positioned. That is, after the first motor 42 and the second motor 43 are fixed, the positioning control module 10 may calculate a position corresponding to a directional direction of the directional antenna 41 as the estimated physical position of the WLAN terminal to be positioned.

For example, the positioning control module 10 may be a wireless intrusion detection/prevention system (WIDS/WIPS) sensor or access point (AP) having an application program for generating and delivering the instructions loaded thereon.

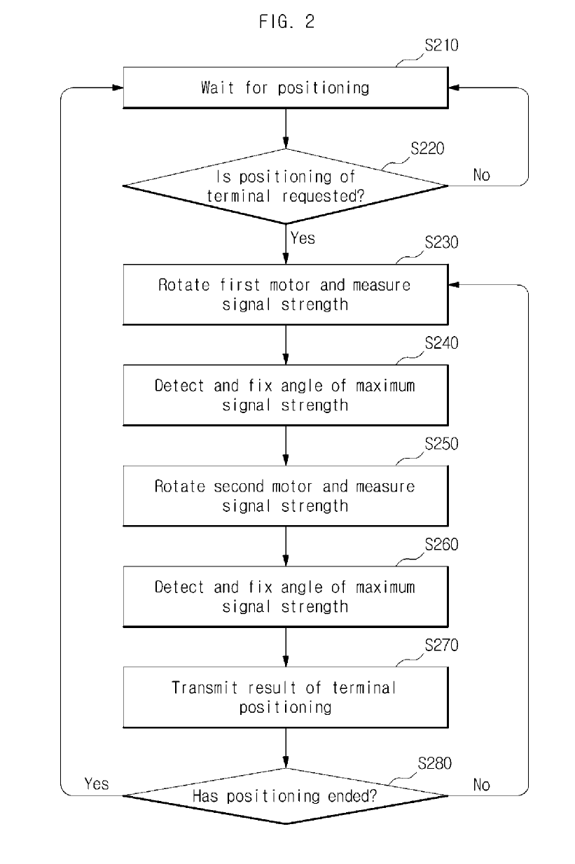

A WLAN terminal positioning method performed by the WLAN terminal positioning apparatus will be described in detail below with respect to FIG. 2.

FIG. 2 is a flowchart illustrating a WLAN terminal positioning method.

In operation S210, the WLAN terminal positioning apparatus waits until a request to position a specific WLAN terminal is received.

In operation S220, the WLAN terminal positioning apparatus determines whether to receive the request to position a specific WLAN terminal. For example, the WLAN terminal positioning apparatus may receive the positioning request including the specific WLAN terminal information from a manager terminal of a network manager. Here, the WLAN terminal information may include additional information, such as a MAC address, a channel, etc. of the WLAN terminal.

In operation S230, when the request to position the specific WLAN terminal is received, the WLAN terminal positioning apparatus sets a monitoring channel and then performs control such that the first motor 42 of the directional antenna module 40 may operate and the WLAN communication module 30 may measure the signal strengths of the signal received from the WLAN terminal by the directional antenna 41 according to the operation of the first motor 42.

In operation S240, the WLAN terminal positioning apparatus detects a maximum signal strength among the measured signal strengths to detect a maximum signal strength angle for the first motor 42 and fixes the first motor 42 such that the directional antenna 41 may be fixed at the detected maximum signal strength angle.

For example, the directional antenna 41, as shown in FIG. 1, may be disposed horizontally with respect to the ceiling 100, that is, vertically with respect to the shaft of the first motor 42, at a search start timing. Thus, the positioning control module 10 may detect a maximum signal strength among signal strengths of the WLAN terminal measured while the first motor 42 is rotated 360 degrees, and detect horizontal angle information corresponding to the detected maximum signal strength. Next, the positioning control module 10 may perform control such that the first motor 42 is fixed in a horizontal angle corresponding to the maximum signal strength.

In operation S250, the WLAN terminal positioning apparatus performs control such that the second motor 43 of the directional antenna module 40 may operate and the WLAN communication module 30 may measure the signal strengths of the signal received from the WLAN terminal by the directional antenna 41 according to the operation of the second motor 43.

In operation S260, the WLAN terminal positioning apparatus detects a maximum signal strength among the measured signal strengths to detect a maximum signal strength angle for the second motor 43 and fixes the second motor 43 such that the directional antenna 41 is fixed at the detected maximum signal strength angle.

For example, the positioning control module 10 may perform control such that the first motor 42 is fixed at a horizontal angle corresponding to the maximum signal strength, detect a maximum signal strength among signal strengths of the WLAN terminal measured while the second motor 43 is rotated 90 degrees in the opposite direction with respect to the ceiling 100, and detect vertical angle information corresponding to the detected maximum signal strength. Next, the positioning control module 10 may perform control such that the second motor 43 is fixed at a vertical angle corresponding to the maximum signal strength.

In operation S270, the WLAN terminal positioning apparatus transmits a result of the terminal positioning to a manager terminal.

For example, the positioning control module 10 may use the horizontal angle information and vertical angle information corresponding to the maximum signal strength to calculate an estimated physical position of the WLAN terminal to be positioned. That is, after the first motor 42 and the second motor 43 are fixed, the positioning control module 10 may calculate a position corresponding to a directional direction of the directional antenna 41 as the estimated physical position of the WLAN terminal to be positioned. Here, the estimated physical position is a position indicated by the directional antenna 41 at an angle at which the first motor 42 and the second motor 43 are fixed. There is a high possibility of the estimated physical position being an actual position of the WLAN terminal to be positioned. The estimated physical position may be corrected when actually calculated, using a correction value obtained through a previous test.

For example, when there is an indoor map of where the WLAN terminal positioning apparatus is currently disposed, for example an office in a building, the WLAN terminal positioning apparatus transmits coordinate information of the estimated physical position on the indoor map to the manager terminal to allow the manager terminal to output the indoor map with the estimated physical position being marked.

For example, a laser point is disposed on the directional antenna 41 to emit a laser beam in a directional direction of the directional antenna 41, and thus the estimated physical position may be directly marked by the laser point. In operation S280, the WLAN terminal positioning apparatus waits for a certain time after the estimated physical position is calculated, and determines whether to complete the positioning. For example, the network manager may check the position of the WLAN terminal to be positioned through the manger terminal that receives the estimated physical position from the WLAN terminal positioning apparatus, and transmit a positioning completion instruction to the WLAN terminal positioning apparatus.

When a certain time elapses without the positioning completion instruction, the position of the WLAN terminal may vary during the certain time. Accordingly, returning to operation S230, the estimated physical position of the WLAN terminal should be calculated.

For example, when the terminal to be positioned does not transmit data continuously and it is difficult to measure the signal strength, the WLAN terminal positioning apparatus may generate and transmit the WLAN packets for inducing data transmission of the WLAN terminal. That is, when the WLAN terminal is operating as an rogue access point (AP) but does not transmit a beacon frame and thus it is difficult to measure the signal strength, the WLAN terminal positioning apparatus may forge and transmit a probe request packet for inducing response of the WLAN terminal, induce the WLAN terminal to transmit a response packet, and then receive the response packet to measure the signal strength.

The present invention can accurately calculate a physical position of an attack terminal in a WLAN using the angle adjustable directional antenna module.

The WLAN terminal positioning method according to an embodiment of the present invention may be implemented as program instructions executable by a means of electronically processing a variety of information recorded on a storage medium. Here, the storage medium may include a program instruction, a data file, a data structure, or a combination thereof.

The program instructions recorded on the storage medium may be designed and configured specifically for the present invention or can be publicly known and available to those who are skilled in the field of software. Examples of the storage medium include a magnetic medium, such as a hard disk, a floppy disk, and a magnetic tape, an optical medium, such as a CD-ROM, a DVD, etc., a magneto-optical medium such as a floptical disk, and a hardware device, such as a ROM, a RAM, a flash memory, etc. specially configured to store and perform program instructions. Meanwhile, the storage medium may be a transmission medium such as an optical or metallic line or a waveguide, including a carrier for transmitting signals to indicate program instructions, a data structure, etc. Examples of the program instructions include not only machine codes made by a compiler but also high-level language codes executable by a device for electrically processing information using an interpreter, for example a computer.

The above exemplary hardware device can be configured to operate as one or more software modules in order to perform the operation of the present invention, and vice versa.

While the example embodiments of the present invention and their advantages have been described in detail, it should be understood that various changes, substitutions, and alterations may be made herein without departing from the scope of the invention.

What is claimed is:

1. A wireless local area network (WLAN) terminal positioning apparatus for performing search of a WLAN terminal, the WLAN terminal positioning apparatus comprising:
a directional antenna module comprising a directional antenna, a first motor, and a second motor wherein the second motor is combined with a shaft of the first motor and the directional antenna is combined with a shaft of the second motor such that the directional antenna has a hemispherical search range;
a motor control module configured to control driving of the first motor and the second motor;
a WLAN communication module configured to receive a signal from the directional antenna to measure signal strengths of the signal, the signal being received by the directional antenna from the WLAN terminal to be positioned; and
a positioning control module configured to receive a request to position the WLAN terminal, perform control such that the directional antenna measures signal strengths of the signal received by the directional antenna from the WLAN terminal while the first motor or the second motor is rotated, detect angle information corresponding to a maximum signal strength for each of the first motor and the second motor, fix the first motor and the second motor using the detected angle information, and calculate an estimated physical position of the WLAN terminal using a directional direction of the directional antenna.

2. The WLAN terminal positioning apparatus of claim 1, wherein the first motor has a shaft rotated in a horizontal direction with respect to a surface where the WLAN terminal positioning apparatus is disposed,
the second motor has a shaft combined with one end of the shaft of the first motor such that the shaft of the second motor is perpendicular to the shaft of the first motor and rotated in a vertical direction with respect to the rotation direction of the shaft of the first motor, and
the directional antenna is combined with the shaft of the second motor such that a directional direction is rotated together with the shaft of the second motor.

3. The WLAN terminal positioning apparatus of claim 2, wherein the positioning control module,
sets the second motor such that the directional antenna is horizontal with respect to the surface at a search start timing,
detects a first maximum signal strength among signal strengths of the WLAN terminal and horizontal angle information corresponding to the detected first maximum signal strength, the signal strengths being measured while the first motor is rotated 360 degrees, and
performs control such that the first motor is fixed using the horizontal angle information.

4. The WLAN terminal positioning apparatus of claim 3, wherein the positioning control module,
detects a second maximum signal strength among signal strengths of the WLAN terminal and vertical angle information corresponding to the detected second maximum signal strength, the signal strengths being measured while the second motor is rotated 90 degrees in an opposite direction with respect to the surface, and
performs control such that the second motor is fixed using the vertical angle information.

5. The WLAN terminal positioning apparatus of claim 4, wherein the positioning control module calculates a position indicated by the directional antenna fixed according to the horizontal angle information and the vertical angle information as an estimated physical position of the WLAN terminal.

6. A wireless local area network (WLAN) terminal positioning method performed by a WLAN terminal positioning apparatus including a directional antenna module, wherein a second motor is combined with a shaft of a first motor and a directional antenna is combined with a shaft of the second motor such that the directional antenna has a hemispherical search range, the WLAN terminal positioning method comprising:
receiving a request to position a WLAN terminal;
measuring signal strengths of a signal received by the directional antenna from the WLAN terminal while the first motor is rotated;
detecting horizontal angle information corresponding to a maximum signal strength among the signal strengths measured according to rotation of the first motor;
fixing the first motor using the horizontal angle information;
measuring signal strengths of a signal received by the directional antenna from the WLAN terminal while the second motor is rotated;
detecting vertical angle information corresponding to a maximum signal strength among the signal strengths measured according to rotation of the second motor;
fixing the second motor using the vertical angle information; and
calculating an estimated physical position of the WLAN terminal using the directional direction of the directional antenna.

7. The WLAN terminal positioning method of claim 6, wherein the first motor has a shaft rotated in a horizontal direction with respect to a surface where the WLAN terminal positioning apparatus is disposed,
the second motor has a shaft combined with one end of the shaft of the first motor such that the shaft of the second motor is perpendicular to the shaft of the first motor and rotated in a vertical direction with respect to the rotation direction of the shaft of the first motor, and
the directional antenna is combined with the shaft of the second motor such that a directional direction is rotated together with the shaft of the second motor.

8. The WLAN terminal positioning method of claim 7, further comprising:
setting the second motor such that the directional antenna is horizontal with respect to the surface before the measuring of signal strengths of a signal received by the directional antenna from the WLAN terminal while the first motor is rotated,
wherein the measuring of signal strengths of a signal received by the directional antenna from the WLAN terminal while the first motor is rotated comprises measuring the signal strengths while the first motor is rotated 360 degrees.

9. The WLAN terminal positioning method of claim 8, wherein the measuring of signal strengths of a signal received by the directional antenna from the WLAN terminal while the second motor is rotated comprises measuring the signal strengths while the second motor is rotated 90 degrees in an opposite direction with respect to the surface.

10. The WLAN terminal positioning method of claim 9, wherein the calculating of the estimated physical position of the WLAN terminal comprises calculating a position indicated by the directional antenna fixed according to the horizontal angle information and the vertical angle information as an estimated physical position of the WLAN terminal.
